(19) United States
(12) Patent Application Publication
(10) Pub. No.: US 2026/0273593 A1
(43) Pub. Date: Sep. 17, 2026

(54) METHOD FOR CLEANING HIGH-PRESSURE GAS CONTAINER

(71) Applicant: Resonac Corporation, Tokyo (JP)

(72) Inventors: Daichi KAWAUCHI, Tokyo (JP); Tomokazu SUGAWARA, Tokyo (JP); Kazunari KAGA, Tokyo (JP)

(73) Assignee: Resonac Corporation, Tokyo (JP)

(21) Appl. No.: 19/167,165

(22) PCT Filed: Jun. 26, 2024
(86) PCT No.: PCT/JP2024/023171

§ 371 Date: Sep. 19, 2025

(30) Foreign Application Priority Data
Jul. 13, 2023 (JP) 2023-115373

(51) Int. Cl. B08B 9/08; B08B 7/04; F17C 13/00

(52) U.S. Cl. CPC B08B 9/08; B08B 7/04; F17C 13/00; B08B 2209/08; F17C 2201/056; F17C 2221/05; F17C 2223/035; F17C 2260/05; F17C 2270/0518

(57) ABSTRACT

A method for cleaning a high-pressure gas container includes a vacuum accumulation purging step and a cleaning step. The vacuum accumulation purging step includes a depressurization stage of reducing the pressure in the high-pressure gas container and an inert gas supply stage of supplying an inert gas to the high-pressure gas container. The cleaning step includes a hydrogen halide supply stage of supplying a hydrogen halide to the high-pressure gas container after the vacuum accumulation purging step, a metal oxide removal stage of reacting, in the high-pressure gas container after the hydrogen halide supply stage, a metal oxide on the inner face of the high-pressure gas container with the hydrogen halide to form water, and a discharge stage of discharging the water formed in the metal oxide removal stage and the hydrogen halide from the high-pressure gas container.

### TECHNICAL FIELD

The present disclosure relates to a method for cleaning a high-pressure gas container.

### BACKGROUND ART

A hydrogen halide (HX) used in semiconductor manufacturing processes is preferably anhydrous and is required to have a moisture concentration of, for example, 1.0 ppm by volume or less. However, when a metal oxide (for example, ferrous oxide (FeO)) is on the inner face of a high-pressure gas container to be filled with a hydrogen halide, the charged hydrogen halide reacts with the metal oxide to form a metal halide (for example, ferrous chloride (FeCl₂)) and water (H₂O).

To remove a metal oxide on the inner face of a high-pressure gas container, a removal method by reacting the metal oxide with a hydrogen halide is used. For example, PTL 1 discloses a method that includes supplying liquefied hydrogen chloride to a high-pressure gas container, reacting a metal oxide on the inner face of the high-pressure gas container with the liquefied hydrogen chloride at a temperature of 30° C. or more and 50° C. or less to form water, and then discharging the liquefied hydrogen chloride containing the formed water from the high-pressure gas container.

### CITATION LIST

### Patent Literature

PTL 1: JP 2002-54799 A

### SUMMARY OF INVENTION

### Technical Problem

The technology disclosed in PTL 1 may insufficiently suppress the formation of water depending on the temperature at which a metal oxide on the inner face of a high-pressure gas container is reacted with liquefied hydrogen chloride, and thus has a room for improvement.

It is an object of the present disclosure to provide a method for cleaning a high-pressure gas container capable of suppressing the formation of water in the high-pressure gas container.

### Solution to Problem

To solve the problems, aspects of the present disclosure are the following [1] to [13].

[1] A method for cleaning a high-pressure gas container including:
a vacuum accumulation purging step of purging the inside of a high-pressure gas container; and
a cleaning step of cleaning the inside of the high-pressure gas container after the vacuum accumulation purging step, in which
the vacuum accumulation purging step includes
a depressurization stage of reducing the pressure in the high-pressure gas container, and
an inert gas supply stage of supplying an inert gas to the high-pressure gas container, and
the cleaning step includes
a hydrogen halide supply stage of supplying a hydrogen halide to the high-pressure gas container after the vacuum accumulation purging step,
a metal oxide removal stage of reacting, in the high-pressure gas container after the hydrogen halide supply stage, a metal oxide on the inner face of the high-pressure gas container with the hydrogen halide supplied in the hydrogen halide supply stage to form water, and
a discharge stage of discharging the water formed in the metal oxide removal stage and the hydrogen halide supplied in the hydrogen halide supply stage from the high-pressure gas container.

[2] The method for cleaning a high-pressure gas container according to the aspect [1], in which the inner face of the high-pressure gas container is not coated with any coating material, and the inner face of the body of the high-pressure gas container has a maximum height roughness Rz of 5 μm or less.

[3] The method for cleaning a high-pressure gas container according to the aspect [1] or [2], in which the depressurization stage in the vacuum accumulation purging step is a step of discharging gas until the internal pressure of the high-pressure gas container reaches 5 Pa or less while the high-pressure gas container is maintained at a temperature of 50° C. or less, and the inert gas supply stage in the vacuum accumulation purging step is a step of supplying an inert gas having a moisture concentration of 0.1 ppm by volume or less to the high-pressure gas container until the internal pressure of the high-pressure gas container reaches 0.1 MPa or more.

[4] The method for cleaning a high-pressure gas container according to any one of the aspects [1] to [3], in which the vacuum accumulation purging step is repeated twice or more.

[5] The method for cleaning a high-pressure gas container according to any one of the aspects [1] to [4], in which the hydrogen halide is at least one of hydrogen fluoride, hydrogen chloride, hydrogen bromide, and hydrogen iodide.

[6] The method for cleaning a high-pressure gas container according to any one of the aspects [1] to [5], in which the hydrogen halide supply stage is a step of supplying a hydrogen halide to the high-pressure gas container until the hydrogen halide is liquefied in the high-pressure gas container.

[7] The method for cleaning a high-pressure gas container according to any one of the aspects [1] to [6], in which the metal oxide removal stage is a step of allowing the high-pressure gas container to which the hydrogen halide has been supplied in the hydrogen halide supply stage, to stand at a temperature of less than 30° C. for one day or more.

[8] The method for cleaning a high-pressure gas container according to any one of the aspects [1] to [7], in which when the high-pressure gas container has a volume of 10 L or more and 50 L or less, the discharge stage is a step of turning the high-pressure gas container upside down to discharge the water and the hydrogen halide from the high-pressure gas container.

[9] The method for cleaning a high-pressure gas container according to any one of the aspects [1] to [7], in which when the high-pressure gas container has a volume of more than 50 L and 1000 L or less, the discharge stage is a step of inserting an insertion tube into the high-pressure gas container and using the insertion tube to discharge the water and the hydrogen halide in the liquid phase from the high-pressure gas container.

[10] The method for cleaning a high-pressure gas container according to any one of the aspects [1] to [7], in which when the high-pressure gas container has a volume of more than 1000 L and 1500 L or less, and two or more of the high-pressure gas containers are connected in parallel through a manifold to form a module body, the discharge stage is a step of inserting insertion tubes into the respective two or more high-pressure gas containers and using the insertion tubes to discharge the water and the hydrogen halide in the liquid phase through the manifold from the respective two or more high-pressure gas containers.

[11] The method for cleaning a high-pressure gas container according to the aspect [10], in which the manifold is connected to one end of each of the two or more high-pressure gas containers, or the manifolds are connected to the respective ends of each of the two or more high-pressure gas containers.

[12] The method for cleaning a high-pressure gas container according to any one of the aspects [1] to [11], in which after the vacuum accumulation purging step, the cleaning step is repeated twice or more.

[13] The method for cleaning a high-pressure gas container according to any one of the aspects [1] to [12], in which the metal oxide is at least one of iron oxide, chromium oxide, molybdenum oxide, and manganese oxide.

### Advantageous Effects of Invention

By using the method for cleaning a high-pressure gas container according to the present disclosure to clean the inside of a high-pressure gas container, the formation of water in the high-pressure gas container can be suppressed.

### BRIEF DESCRIPTION OF DRAWINGS

FIG. 1 is a schematic view illustrating an example apparatus for performing a hydrogen halide supply stage and a discharge stage in a method for cleaning a high-pressure gas container according to an embodiment of the present disclosure;

FIG. 2 is a schematic view illustrating an example apparatus for performing a vacuum accumulation purging step in a method for cleaning a high-pressure gas container according to an embodiment of the present disclosure;

FIG. 3 is a sectional view illustrating an example high-pressure gas container usable in a method for cleaning a high-pressure gas container according to an embodiment of the present disclosure;

FIG. 4 is a sectional view illustrating an example high-pressure gas container usable in a method for cleaning a high-pressure gas container according to an embodiment of the present disclosure; and

FIG. 5 are a plan view and an elevation view of a module body illustrating example high-pressure gas containers usable in a method for cleaning a high-pressure gas container according to an embodiment of the present disclosure.

### DESCRIPTION OF EMBODIMENTS

One embodiment of the present disclosure will now be described. The embodiment is merely one example of the present disclosure, and the present disclosure is not limited to the embodiment. Various modifications or improvements can be made in the embodiment, and such modifications and improvements can be encompassed by the present disclosure.

A method for cleaning a high-pressure gas container according to the present embodiment includes a vacuum accumulation purging step of purging the inside of a high-pressure gas container and a cleaning step of cleaning the inside of the high-pressure gas container after the vacuum accumulation purging step. The vacuum accumulation purging step includes a depressurization stage of reducing the pressure in the high-pressure gas container and an inert gas supply stage of supplying an inert gas to the high-pressure gas container. The cleaning step includes a hydrogen halide supply stage of supplying a hydrogen halide to the high-pressure gas container after the vacuum accumulation purging step, a metal oxide removal stage of reacting, in the high-pressure gas container after the hydrogen halide supply stage, a metal oxide on the inner face of the high-pressure gas container with the hydrogen halide supplied in the hydrogen halide supply stage to form water, and a discharge stage of discharging the water formed in the metal oxide removal stage and the hydrogen halide supplied in the hydrogen halide supply stage from the high-pressure gas container.

The method for cleaning a high-pressure gas container according to the present embodiment includes a vacuum accumulation purging step of purging the inside of a high-pressure gas container and a cleaning step of cleaning the inside of the high-pressure gas container after the vacuum accumulation purging step.

The vacuum accumulation purging step includes a depressurization stage and an inert gas supply stage. The depressurization stage is a step of reducing the pressure in the high-pressure gas container. The inert gas supply stage is a step of supplying an inert gas to the high-pressure gas container. The cleaning step includes a hydrogen halide supply stage, a metal oxide removal stage, and a discharge stage. The hydrogen halide supply stage is a step of supplying a hydrogen halide to the high-pressure gas container after the vacuum accumulation purging step.

The metal oxide removal stage is a step of reacting, in the high-pressure gas container after the hydrogen halide supply stage, a metal oxide on the inner face of the high-pressure gas container with the hydrogen halide supplied in the hydrogen halide supply stage to form water. The discharge stage is a step of discharging the water formed in the metal oxide removal stage and the hydrogen halide supplied in the hydrogen halide supply stage from the high-pressure gas container.

The method for cleaning a high-pressure gas container according to the present embodiment includes the vacuum accumulation purging step and the cleaning step. Hence, by using the method for cleaning a high-pressure gas container according to the present embodiment to clean the inside of a high-pressure gas container, a metal oxide that is to form water is removed, and the formation of water in the high-pressure gas container can be suppressed.

Such a method for cleaning a high-pressure gas container according to the present embodiment is suitable as the method for cleaning a high-pressure gas container that is to be filled with and to store a hydrogen halide used for semiconductor manufacturing processes. In the high-pressure gas container cleaned by the method for cleaning a high-pressure gas container according to the present embodiment, water is unlikely to be formed, and thus a charged hydrogen halide can be maintained to have a low moisture concentration (for example, 1.0 ppm by volume or less). More specifically, by using the high-pressure gas container cleaned by the method for cleaning a high-pressure gas container according to the present embodiment, a high-quality hydrogen halide can be prepared.

For the hydrogen halide used in semiconductor manufacturing processes, the concentration of molecular hydrogen (H₂) is also restricted and is, for example, required to be reduced to 10 ppm by volume or less. However, it is known that the reaction of a zero-valent metal (for example, iron) on the inner face of a high-pressure gas container with a hydrogen halide yields ferrous chloride and molecular hydrogen. The reaction of forming molecular hydrogen is an endothermic reaction and thus proceeds more easily as the reaction temperature increases. Hence, for example, the method according to PTL 1 is a method in which a high-pressure gas container containing a hydrogen halide is heated, and thus may promote the formation of molecular hydrogen, unfortunately.

The method for cleaning a high-pressure gas container according to the present embodiment eliminates the need of heating a high-pressure gas container containing a hydrogen halide, and accordingly suppresses the formation of molecular hydrogen. This can suppress an increase in the concentration of molecular hydrogen in a hydrogen halide and can maintain the concentration at 10 ppm by volume or less.

As a high-pressure gas container becomes larger, heat treatment of the high-pressure gas container becomes more difficult. The method for cleaning a high-pressure gas container according to the present embodiment eliminates the need of heat treatment of a high-pressure gas container and can remove a metal oxide from the inside of a high-pressure gas container under mild conditions.

The high-pressure gas container cleaned by the method for cleaning a high-pressure gas container according to the present embodiment can be filled with not only a hydrogen halide but also various gases and can store such a gas.

Hereinafter, the method for cleaning a high-pressure gas container according to the present embodiment will be described in further detail.

### [High-Pressure Gas Container]

The high-pressure gas container used in the method for cleaning a high-pressure gas container according to the present embodiment is a container that is used for discharge or filling of a gas through a gas flow path. The high-pressure gas container used in the method for cleaning a high-pressure gas container according to the present embodiment is not particularly limited, and, for example, the size and the shape are not particularly limited. The material of the high-pressure gas container is not particularly limited, and examples include a metal material containing at least one of iron (Fe), chromium (Cr), molybdenum (Mo), and manganese (Mn).

The high-pressure gas container used in the method for cleaning a high-pressure gas container according to the present embodiment may be a new (unused) high-pressure gas container or a used high-pressure gas container. The high-pressure gas container may be a high-pressure gas container open to the atmosphere or a high-pressure gas container not open to the atmosphere.

The condition of the inner face of the high-pressure gas container is not particularly limited, and the inner face of the high-pressure gas container may be coated or not coated with a coating material. Examples of the coating material coated on the inner face of the high-pressure gas container include nickel (Ni) plating, nickel-phosphorus alloy (Ni—P) plating, zinc (Zn) plating, gold (Au) plating, and silver (Ag) plating.

The surface roughness of the inner face of the high-pressure gas container is not particularly limited, and the inner face of the body of the high-pressure gas container preferably has a maximum height roughness Rz of 5 μm or less. The inner face of the high-pressure gas container may not be coated with any coating material, and the inner face of the body of the high-pressure gas container may have a maximum height roughness Rz of 5 μm or less. When the inner face of the high-pressure gas container has a small surface roughness (smooth face), the quality of a hydrogen halide charged after cleaning can be maintained at a high level even when the method for cleaning a high-pressure gas container is simplified. As compared with conventional methods for cleaning a high-pressure gas container, the quality of a hydrogen halide can be improved.

The inner face of the body of the high-pressure gas container more preferably has a maximum height roughness Rz of 1 μm or more and 5 μm or less, and the inner face of portions other than the body of the high-pressure gas container more preferably has a maximum height roughness Rz of 15 μm or more and 20 μm or less. The inner face of the body of the high-pressure gas container even more preferably has a maximum height roughness Rz of 1 μm or less, and the inner face of portions other than the body of the high-pressure gas container even more preferably has a maximum height roughness Rz of 15 μm or more and 20 μm or less. The inner face of the body of the high-pressure gas container particularly preferably has a maximum height roughness Rz of 1 μm or less, and the inner face of portions other than the body of the high-pressure gas container particularly preferably has a maximum height roughness Rz of 1 μm or less.

The “body” of a high-pressure gas container in the present disclosure means the central portion in the long axis direction of the high-pressure gas container excluding the respective ends in the long axis direction. The end means a portion having 5% by volume of the volume of a high-pressure gas container.

For example, for a high-pressure gas container having a cylindrical shape or a prismatic shape, the body means the central portion excluding the respective ends in the height direction (length direction) of the cylinder or prism. For a high-pressure gas container having a spherical shape, the body means the central portion excluding the respective ends in the radial direction of the sphere.

The method of reducing the maximum height roughness Rz of the inner face of the body of a high-pressure gas container is not particularly limited, and examples include a method of polishing the inner face of the body of a high-pressure gas container. Examples of the method of polishing the inner face of the body of a high-pressure gas container include shot blasting, barrel polishing, and electrolytic polishing.

The method of measuring the maximum height roughness Rz of the inner face of the body of a high-pressure gas container is not particularly limited, and, for example, the method according to Japanese Industrial Standard JIS B0601-2013 may be used.

The measurement apparatus for measuring the maximum height roughness Rz of the inner face of the body of a high-pressure gas container is not particularly limited, and, for example, a stylus-type surface roughness measuring instrument such as Portable Surface Roughness Measurement SURFTEST SJ-210 series manufactured by Mitutoyo Corporation may be used.

The method for cleaning a high-pressure gas container according to the present embodiment is applicable to the cleaning of any high-pressure gas container, but is particularly suitable to clean a high-pressure gas container in which the inner face is not coated with any coating material and the inner face of the body has a maximum height roughness Rz of 5 μm or less.

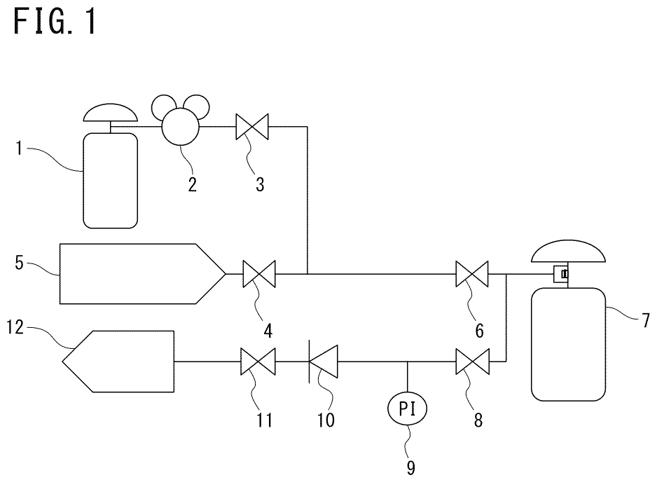

With reference to FIGS. 1 to 4, an example of the method for cleaning a high-pressure gas container according to the present embodiment will next be described.

### [Vacuum Accumulation Purging Step]

For the high-pressure gas container to be subjected to the cleaning step, water in the container is required to be removed in advance by the vacuum accumulation purging step of purging the inside of a high-pressure gas container.

The vacuum accumulation purging step includes a depressurization stage of reducing the pressure in the high-pressure gas container and an inert gas supply stage of supplying an inert gas to the high-pressure gas container, but the order of the depressurization stage and the inert gas supply stage is not particularly limited. More specifically, the depressurization stage may be performed first, and then the high-pressure gas container after the depressurization stage may be subjected to the inert gas supply stage of supplying an inert gas. Alternatively, the inert gas supply stage may be performed first, and then the high-pressure gas container after the inert gas supply stage may be subjected to the depressurization stage of reducing the pressure in the high-pressure gas container. That is to say, the vacuum accumulation purging step is a step in which one of the depressurization stage and the inert gas supply stage is performed, and then the other is performed.

When the depressurization stage is followed by the inert gas supply stage, the amount of an inert gas used in the inert gas supply stage is reduced. When the vacuum accumulation purging step is repeated twice or more, and the depressurization stage is followed by the inert gas supply stage, components derived from the atmosphere in the high-pressure gas container can be removed in advance in the depressurization stage. In addition, an inert gas supplied to the high-pressure gas container in the inert gas supply stage after the depressurization stage easily spreads evenly in the high-pressure gas container, and thus impurities are easily removed from the high-pressure gas container in the subsequent depressurization stage.

When the inert gas supply stage is followed by the depressurization stage, the time required for the depressurization stage can be reduced. More specifically, in a high-pressure gas container containing a large amount of water, the water adsorbs to the inner face of the high-pressure gas container, and thus the time required to reach an intended vacuum level in the depressurization stage becomes longer. When the inert gas supply stage is followed by the depressurization stage, water can be discharged from the high-pressure gas container together with the inert gas, and thus the time required for the depressurization stage can be reduced.

In the present disclosure, “vacuum accumulation purging” means the following process. More specifically, “vacuum accumulation purging” means the process including: first, supplying an inert gas into a high-pressure gas container until the pressure in the high-pressure gas container reaches a predetermined pressure; and after, for example, a certain period of time, discharging the inert gas in the high-pressure gas container by using, for example, a vacuum pump to reduce the pressure in the high-pressure gas container to atmospheric pressure or below. Specific examples of the process include a process including: supplying an inert gas to a high-pressure gas container and filling the container with the inert gas; and after the pressure in the high-pressure gas container reaches a predetermined pressure, discharging the inert gas in the high-pressure gas container to reduce the pressure in the high-pressure gas container to atmospheric pressure or below.

Alternatively, “vacuum accumulation purging” means the process including; first, discharging the gas in a high-pressure gas container by using, for example, a vacuum pump to reduce the pressure in the high-pressure gas container to atmospheric pressure or below; and then supplying an inert gas to the high-pressure gas container until the pressure in the high-pressure gas container reaches a predetermined pressure.

The above predetermined pressure is not particularly limited and may be atmospheric pressure (0.1013 MPa), a pressure less than atmospheric pressure, or a pressure more than atmospheric pressure.

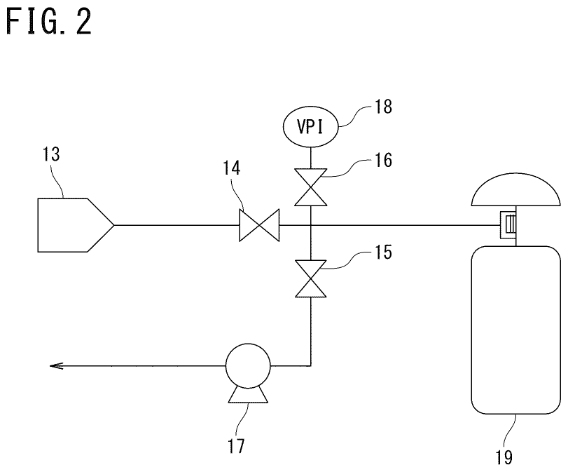

With reference to FIG. 2, the vacuum accumulation purging step will be described. FIG. 2 is a view illustrating an example apparatus for performing the vacuum accumulation purging step. In the following description, an example vacuum accumulation purging step in which the depressurization stage is followed by the inert gas supply stage will be described.

First, the depressurization stage is performed to reduce the pressure in a high-pressure gas container 19 having, for example, a volume of 47 L. More specifically, a vacuum pump 17 is used to discharge water and other gases in the high-pressure gas container 19. The depressurization stage is preferably performed while the temperature of the high-pressure gas container 19 is maintained at 50° C. or less. The ultimate pressure in the high-pressure gas container 19 after the depressurization stage is preferably 5 Pa or less, more preferably 1 Pa or less, and even more preferably less than 0.01 Pa. The vacuum pump 17 is preferably a dry vacuum pump.

Subsequently, the high-pressure gas container 19 after the depressurization stage is subjected to the inert gas supply stage of supplying an inert gas until the internal pressure reaches a predefined pressure. The type of inert gas is not particularly limited, and examples include nitrogen gas (N₂), helium (He), argon (Ar), and xenon (Xe). In FIG. 2, nitrogen gas is used as the inert gas as an example. Before the inert gas supply stage, nitrogen gas is preferably allowed to flow from a nitrogen gas supply source 13 through piping to discharge water in the piping.

The moisture concentration in the inert gas such as nitrogen gas used in the inert gas supply stage is preferably 0.5 ppm by volume or less, more preferably 0.1 ppm by volume or less, and even more preferably 0.05 ppm by volume or less.

The filling pressure when the inert gas such as nitrogen gas is supplied to the high-pressure gas container 19 is preferably 0.1 MPa or more, more preferably 0.5 MPa or more, and even more preferably 1.5 MPa or more.

The vacuum accumulation purging step may be performed once or may be repeated twice or more. More specifically, each of the depressurization stage and the inert gas supply stage may be performed once, or each may be repeated twice or more alternately.

After completion of the inert gas supply stage, the moisture concentration of the nitrogen gas charged in the high-pressure gas container 19 may be determined. The moisture concentration of the nitrogen gas may be determined by using a moisture meter. As the moisture meter, a cavity ring-down spectroscopy (CRDS) analyzer may be used.

The depressurization stage in the vacuum accumulation purging step may be a step of discharging gas until the internal pressure of the high-pressure gas container reaches 5 Pa or less while the high-pressure gas container is maintained at a temperature of 50° C. or less, and the inert gas supply stage in the vacuum accumulation purging step may be a step of supplying an inert gas having a moisture concentration of 0.1 ppm by volume or less to the high-pressure gas container until the internal pressure of the high-pressure gas container reaches 0.1 MPa or more.

### [Cleaning Step]

After completion of the vacuum accumulation purging step, a cleaning step of cleaning the inside of the high-pressure gas container is performed. FIG. 1 is a view illustrating an example apparatus for performing the cleaning step. With reference to FIG. 1, the cleaning step will be described.

First, the inside of the high-pressure gas container 19 after the vacuum accumulation purging step is evacuated, and the container is detached from the apparatus illustrated in FIG. 2 and is attached to the apparatus illustrated in FIG. 1. In FIG. 1, the “high-pressure gas container 19” is indicated as a “high-pressure gas container 7”. Next, a hydrogen halide supply stage of supplying a hydrogen halide to the high-pressure gas container 7 is performed, but before the hydrogen halide supply stage, the following process is preferably performed. More specifically, into the piping located upstream of the high-pressure gas container 7 of the apparatus illustrated in FIG. 1, a hydrogen halide is supplied to increase the pressure to 0.1 MPaG or more, and then a discharge means 12 is used to reduce the pressure to around atmospheric pressure. The process is preferably repeated to remove air and water in the apparatus illustrated in FIG. 1.

After the above process, the hydrogen halide supply stage is performed. In the hydrogen halide supply stage, a hydrogen halide is preferably supplied to the high-pressure gas container until the hydrogen halide is liquefied in the high-pressure gas container. More specifically, a hydrogen halide is supplied from a hydrogen halide supply source 5 to the high-pressure gas container 7, and the hydrogen halide may be continuously supplied until the hydrogen halide exists in the high-pressure gas container 7 in separate two phases, the gas phase and the liquid phase (until the hydrogen halide is partially liquefied). The mass of the hydrogen halide supplied to the high-pressure gas container 7 may be weighed with a scale. The mass of the hydrogen halide supplied to a high-pressure gas container 7 having a volume of 47 L is preferably 5 kg or more and 30 kg or less.

The type of hydrogen halide is not particularly limited, and may be at least one of hydrogen fluoride (HF), hydrogen chloride (HCl), hydrogen bromide (HBr), and hydrogen iodide (HI). In FIG. 1, hydrogen chloride is used as the hydrogen halide as an example.

The moisture concentration of the hydrogen halide supplied from the hydrogen halide supply source 5 to the high-pressure gas container 7 is preferably 0.2 ppm by volume or less, more preferably 0.1 ppm by volume or less, and even more preferably 0.05 ppm by volume or less.

The purity of the hydrogen halide supplied from the hydrogen halide supply source 5 to the high-pressure gas container 7 is preferably 3 N or more (99.9% by volume or more), more preferably 4 N or more (99.99% by volume or more), and even more preferably 5 N or more (99.999% by volume or more).

Before the high-pressure gas container 7 to which a hydrogen halide has been supplied is detached from the apparatus illustrated in FIG. 1, the hydrogen halide in the apparatus illustrated in FIG. 1 is preferably removed. More specifically, into the apparatus illustrated in FIG. 1, helium is supplied from a helium cylinder 1 for purging to increase the pressure in the apparatus illustrated in FIG. 1 to a pressure of 1.0 MPaG or more, and then the discharge means 12 is used to reduce the pressure to around atmospheric pressure. The process is preferably repeated to remove the hydrogen halide in the apparatus illustrated in FIG. 1.

From the apparatus illustrated in FIG. 1, the high-pressure gas container 7 is detached, and is subjected to the metal oxide removal stage. More specifically, in the high-pressure gas container 7 after the hydrogen halide supply stage, a metal oxide on the inner face of the high-pressure gas container 7 is reacted with the hydrogen halide supplied in the hydrogen halide supply stage to form water.

The type of metal oxide is not particularly limited, and examples include at least one of iron oxide, chromium oxide, molybdenum oxide, and manganese oxide.

The metal oxide removal stage may be performed by allowing the high-pressure gas container 7 after the hydrogen halide supply stage to stand at a predefined temperature for a predefined time period. The temperature in the metal oxide removal stage is preferably less than 30° C. The time period in the metal oxide removal stage is preferably one day or more, more preferably 10 days or more, and even more preferably 60 days or more. More specifically, the metal oxide removal stage may be a step of allowing the high-pressure gas container to which a hydrogen halide has been supplied in the hydrogen halide supply stage to stand at a temperature of less than 30° C. for one day or more.

The method of setting the high-pressure gas container 7 at a temperature of less than 30° C. is not particularly limited, and examples include a method of using an air conditioning apparatus such as an air conditioner. In the metal oxide removal stage, the room temperature or ambient temperature of the environment in which the high-pressure gas container 7 is placed is thought to affect the reaction rate between the metal oxide and the hydrogen halide to some extent, but the effect is negligible in the temperature range of less than 30° C. Accordingly, in the temperature range of less than 30° C., the number of times of cleaning step to achieve an intended cleaning effect does not increase depending on temperatures. In the metal oxide removal stage, the inside of the high-pressure gas container 7 is a closed space and thus is hardly affected by humidity or atmosphere outside the high-pressure gas container 7.

Next, the water formed by the reaction between a metal oxide and a hydrogen halide in the metal oxide removal stage is discharged together with an excess hydrogen halide that has been supplied in the hydrogen halide supply stage but has not consumed by the reaction in the metal oxide removal stage, from the high-pressure gas container 7 in the discharge stage. In the discharge stage, a metal halide formed by the reaction between a metal oxide and a hydrogen halide in the metal oxide removal stage may also be discharged from the high-pressure gas container 7.

The apparatus illustrated in FIG. 1 is used to discharge water and a hydrogen halide from the high-pressure gas container 7. Considering the distribution coefficient of water in a hydrogen halide, water can be more efficiently discharged from the high-pressure gas container 7 by discharging a hydrogen halide containing water from the liquid phase side rather than from the gas phase side.

For example, for a high-pressure gas container having a volume of 10 L or more and 50 L or less, the discharge stage is preferably a step of turning the high-pressure gas container upside down to discharge water and a hydrogen halide from the high-pressure gas container. More specifically, a compact high-pressure gas container having a volume of 10 L or more and 50 L or less has only one container valve, and thus to discharge a hydrogen halide from the liquid phase side, the high-pressure gas container is preferably set such that the container valve faces vertically downward, and the liquefied hydrogen halide is preferably discharged from the high-pressure gas container.

A compact high-pressure gas container having a volume of 10 L or more and 50 L or less is preferably set such that the container valve faces vertically downward, but is not required to be placed upright. As long as the container valve faces vertically downward, the container may be tilted. The tilt angle is not particularly limited, but is preferably, for example, 45° or more and less than 90°.

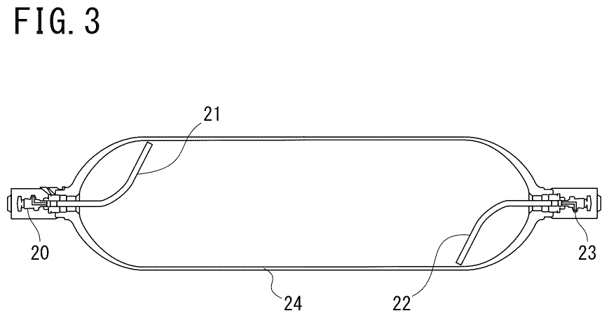

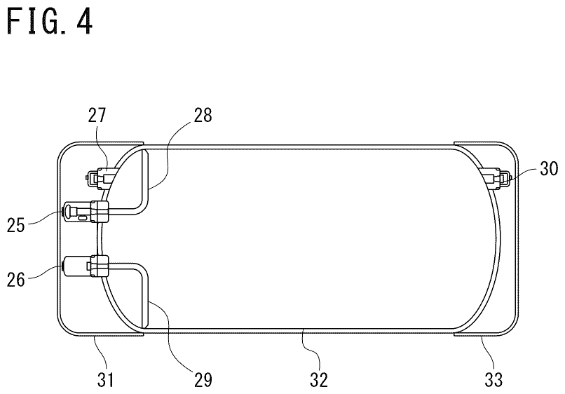

For example, for a high-pressure gas container having a volume of more than 50 L and 1000 L or less, the discharge stage is preferably a step of inserting an insertion tube into the high-pressure gas container and using the insertion tube to discharge water and a hydrogen halide in the liquid phase from the high-pressure gas container. For a high-pressure gas container 24 having a volume of 440 L illustrated in FIG. 3 or a high-pressure gas container 32 having a volume of 900 L illustrated in FIG. 4, a gas phase siphon tube 21, 28 and a liquid phase siphon tube 22, 29 are inserted into the high-pressure gas container (the gas phase siphon tube 21, 28 and the liquid phase siphon tube 22, 29 correspond to the insertion tube as a constituent element of the present disclosure). Hence, the downward-facing liquid phase siphon tube 22, 29 can be used to discharge the liquefied hydrogen halide from the liquid phase side to the outside of the high-pressure gas container 24, 32, and this enables efficient discharge of water contained in the hydrogen halide to the outside of the high-pressure gas container 24, 32.

Even when two or more high-pressure gas containers are connected in parallel through a manifold to form a module body, insertion tubes may be used to discharge water and a hydrogen halide in the liquid phase from the high-pressure gas containers as with the above. More specifically, when two or more high-pressure gas containers each having a volume of more than 1000 L and 1500 L or less are connected in parallel through a manifold to form a module body, the discharge stage is preferably a step of inserting insertion tubes into the respective two or more high-pressure gas containers and using the insertion tubes to discharge water and a hydrogen halide in the liquid phase through the manifold from the respective two or more high-pressure gas containers.

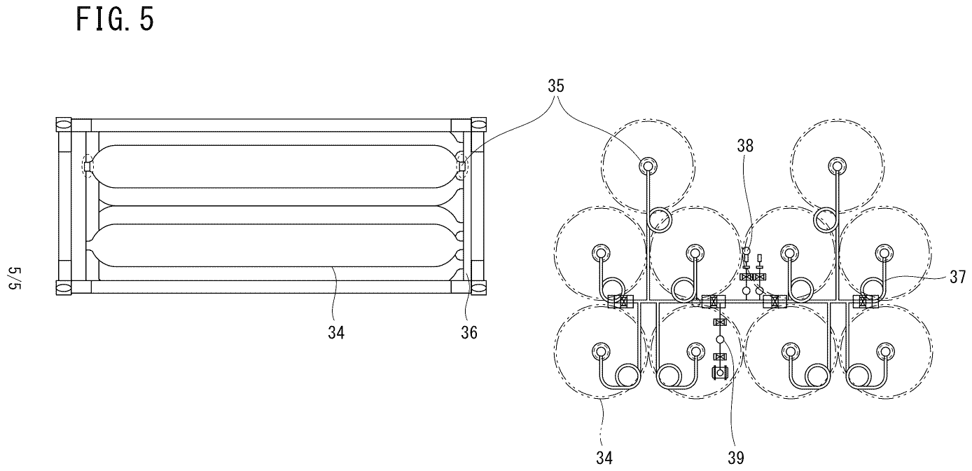

With reference to FIG. 5, an example method for cleaning high-pressure gas containers included in a module body will be described. First, before high-pressure gas containers 34 are filled with a hydrogen halide from one manifold of two manifolds connected to the respective ends of each high-pressure gas container 34, the one manifold and a filling line (not illustrated) are subjected to vacuum accumulation purging with an inert gas.

After completion of the vacuum accumulation purging of the one manifold and the filling line (not illustrated), the container valves 35 of all the high-pressure gas containers 34 are opened, and the high-pressure gas containers 34 and the other manifold are subjected to vacuum accumulation purging with an inert gas. When a manifold is connected to only one end of each high-pressure gas container 34, all the container valves 35 that separate the manifold and the high-pressure gas containers 34 are opened, and vacuum accumulation purging is performed. Vacuum accumulation purging of such a module body is performed by repeating the process of supplying an inert gas to increase the pressure and then reducing the pressure to around atmospheric pressure, as with the above.

Subsequently, a hydrogen halide is used to clean the high-pressure gas containers 34. First, to the one manifold and the filling line (not illustrated), a hydrogen halide is supplied until the hydrogen halide exists only in the gas phase or exists in the gas phase and the liquid phase. The supplied amount of the hydrogen halide may be controlled by a pressure gauge 38 installed on the manifold or may be controlled by determining, with a scale, a change in the mass of the high-pressure gas container 34 that is installed on the scale. Then, the hydrogen halide supplied to the high-pressure gas containers 34 is blown to a pressure higher than the normal pressure. Supplying and blowing the hydrogen halide are alternately repeated predefined times.

Next, through the one manifold, a hydrogen halide is supplied to each high-pressure gas container 34. A hydrogen halide is preferably supplied until the hydrogen halide exists in the high-pressure gas container 34 in separate two phases, the gas phase and the liquid phase (until the hydrogen halide is partially liquefied).

When manifolds are connected to the respective ends of each high-pressure gas container 34, a hydrogen halide is supplied to all the high-pressure gas containers 34 included in the module body, and then the other manifold is cleaned concurrently with cleaning all the high-pressure gas containers 34. More specifically, the container valve 35 (the container valve connected to the other manifold) of at least one high-pressure gas container 34 of all the high-pressure gas containers 34 to which a hydrogen halide has been supplied is opened, and the hydrogen halide is supplied to the other manifold. Accordingly, all the high-pressure gas containers 34 and the other manifold are cleaned concurrently.

Cleaning in a manifold with a hydrogen halide is optional. Only the high-pressure gas containers 34 may be filled with a hydrogen halide to clean only the high-pressure gas containers 34, and the manifold may be simply purged with an inert gas after the high-pressure gas containers 34 are filled with a hydrogen halide.

After completion of supplying a hydrogen halide to all the high-pressure gas containers 34 and the manifolds, the metal oxide removal stage is performed in the same manner as above. For the stage, the module body may be allowed to stand or may be transported on a chassis (carriage).

After completion of the metal oxide removal stage, the hydrogen halide in the high-pressure gas containers 34 and the manifolds is discharged together with the formed water and metal halide to the outside of the module body. As described above, impurities such as water can be more efficiently discharged from the high-pressure gas containers 34 by discharging the hydrogen halide from the liquid phase side rather than from the gas phase side. Hence, the hydrogen halide is discharged through the manifold at the liquid phase side. The hydrogen halide is preferably discharged from each high-pressure gas container 34 such that impurities are not unevenly distributed in high-pressure gas containers 34 located at the bottom of the module body.

Such a cleaning step may be performed once after the vacuum accumulation purging step or may be repeated twice or more after the vacuum accumulation purging step.

After completion of the cleaning step, the moisture concentration and the molecular hydrogen concentration in the hydrogen halide discharged in the discharge stage may each be determined. The moisture concentration of a hydrogen halide may be determined with a cavity ring-down spectroscopy analyzer. The molecular hydrogen concentration of a hydrogen halide may be determined by, for example, gas chromatography (GC). As the detector for the gas chromatography, a pulsed discharge photo-ionization detector may be used.

The high-pressure gas container cleaned as above is usable as a high-pressure gas container that is to be filled with and to store a hydrogen halide. More specifically, by filling the high-pressure gas container cleaned as above with a hydrogen halide, the moisture concentration of the charged hydrogen halide can be maintained at a low level (for example, 1.0 ppm by volume or less). The type of hydrogen halide to be filled is not particularly limited, and may be at least one of hydrogen fluoride, hydrogen chloride, hydrogen bromide, and hydrogen iodide.

### EXAMPLES

The present disclosure will be described below in further detail with reference to examples and comparative examples.

### Example 1

A metal high-pressure gas container having a volume of 47 L was prepared. The inner face of the high-pressure gas container was polished so that the inner face of the body had a maximum height roughness Rz of 1 μm, and the inner face of portions other than the body had a maximum height roughness Rz of 20 μm. The inner face of the high-pressure gas container was not coated with any coating material.

The high-pressure gas container was attached to the apparatus illustrated in FIG. 2 and was subjected to the vacuum accumulation purging step. More specifically, the depressurization stage was performed to reduce the pressure until the internal pressure of the high-pressure gas container reached 3 Pa while the temperature was maintained within a range of 15° C. or more and 25° C. or less, and then the inert gas supply stage was performed to fill the high-pressure gas container with nitrogen gas having a moisture concentration of less than 0.05 ppm by volume until the internal pressure of the high-pressure gas container reached 0.3 MPa. The depressurization stage and the inert gas supply stage were alternately repeated five times. The moisture concentration of the nitrogen gas charged in the high-pressure gas container was determined with a cavity ring-down spectroscopy (CRDS) analyzer to be 0.1 ppm by volume or less.

Next, the high-pressure gas container after the vacuum accumulation purging step was depressurized in the same conditions as the depressurization stage in the vacuum accumulation purging step, and then the high-pressure gas container was detached from the apparatus illustrated in FIG. 2 and was attached to the apparatus illustrated in FIG. 1. Then, the container valve of the high-pressure gas container was closed. Hydrogen chloride was supplied into the apparatus illustrated in FIG. 1 until the pressure reached 1.80 MPaG, and the apparatus was decompressed until the residual pressure reached 0.1 MPaG. The process was repeated five times in total.

Subsequently, the high-pressure gas container was subjected to the cleaning step. More specifically, the container valve of the high-pressure gas container was opened. The high-pressure gas container was filled with 25 kg of hydrogen chloride having a moisture concentration of 0.2 ppm by volume or less (hydrogen halide supply stage), and then was allowed to stand for 24 hours while the temperature was maintained within a range of 15° C. or more and 25° C. or less (metal oxide removal stage). Then, the container valve of the high-pressure gas container was closed, and the container was detached from the apparatus illustrated in FIG. 1. The high-pressure gas container was turned upside down (such that the container valve faced vertically downward), and the container valve was opened to discharge the hydrogen chloride from the high-pressure gas container until the residual pressure reached 0.11 MPa (discharge stage). The cleaning step as above was repeated four times in total.

The high-pressure gas container after the cleaning step was refilled with 25 kg of hydrogen chloride having a moisture concentration of 0.2 ppm by volume or less. Then, the moisture concentration of the hydrogen chloride charged in the high-pressure gas container was determined with a cavity ring-down spectroscopy (CRDS) analyzer, and the molecular hydrogen concentration was determined by gas chromatography (GC). As the detector for the gas chromatography, a pulsed discharge photo-ionization detector was used. As a result, the moisture concentration of the hydrogen chloride was 0.6 ppm by volume, and the molecular hydrogen concentration of the hydrogen chloride was 0.1 ppm by volume or less. The results are shown in Table 1.

### Example 2

A metal high-pressure gas container having a volume of 440 L was prepared (see FIG. 3). The inner face of the high-pressure gas container was polished so that the inner face of the body had a maximum height roughness Rz of 1 μm, and the inner face of portions other than the body had a maximum height roughness Rz of 20 μm. The inner face of the high-pressure gas container was not coated with any coating material.

The vacuum accumulation purging step was performed in the same manner as in Example 1 except that the high-pressure gas container was changed from the container having a volume of 47 L to the container having a volume of 440 L. However, the vacuum accumulation purging step was repeated twice. More specifically, the depressurization stage and the inert gas supply stage were alternately repeated twice. The moisture concentration of the nitrogen gas charged in the high-pressure gas container was determined with a cavity ring-down spectroscopy (CRDS) analyzer to be 0.1 ppm by volume or less.

Next, the high-pressure gas container after the vacuum accumulation purging step was detached from the apparatus illustrated in FIG. 2 and was attached to the apparatus illustrated in FIG. 1 from the container valve side. Then, the container valve of the high-pressure gas container was closed. Hydrogen chloride was supplied into the apparatus illustrated in FIG. 1 until the pressure reached 1.80 MPaG, and the apparatus was decompressed until the residual pressure reached 0.1 MPaG. The process was repeated five times in total.

Subsequently, the high-pressure gas container was subjected to the cleaning step. More specifically, the container valve of the high-pressure gas container was opened. The high-pressure gas container was filled with 250 kg of hydrogen chloride having a moisture concentration of 0.2 ppm by volume or less (hydrogen halide supply stage), and then was allowed to stand for 24 hours while the temperature was maintained within a range of 15° C. or more and 25° C. or less (metal oxide removal stage). Then, the container valve of the high-pressure gas container was closed, and the container was detached from the apparatus illustrated in FIG. 1. The hydrogen chloride was discharged through a liquid phase siphon tube from the high-pressure gas container until the residual pressure reached 0.11 MPa (discharge stage). The cleaning step was performed once.

The high-pressure gas container after the cleaning step was refilled with 250 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 0.5 ppm by volume, and the molecular hydrogen concentration of the hydrogen chloride was 0.1 ppm by volume or less. The results are shown in Table 1.

### Example 3

A metal high-pressure gas container having a volume of 900 L was prepared (see FIG. 4). The inner face of the high-pressure gas container was polished so that the inner face of the body had a maximum height roughness Rz of 1 μm, and the inner face of portions other than the body had a maximum height roughness Rz of 20 μm. The inner face of the high-pressure gas container was not coated with any coating material.

The vacuum accumulation purging step was performed in the same manner as in Example 2 except that the high-pressure gas container was changed from the container having a volume of 440 L to the container having a volume of 900 L. However, the vacuum accumulation purging step was repeated three times. More specifically, the depressurization stage and the inert gas supply stage were alternately repeated three times. The moisture concentration of the nitrogen gas charged in the high-pressure gas container was determined with a cavity ring-down spectroscopy (CRDS) analyzer to be 0.1 ppm by volume or less.

Next, the high-pressure gas container after the vacuum accumulation purging step was detached from the apparatus illustrated in FIG. 2 and was attached to the apparatus illustrated in FIG. 1 from the container valve side. Then, the container valve of the high-pressure gas container was closed. Hydrogen chloride was supplied into the apparatus illustrated in FIG. 1 until the pressure reached 1.80 MPaG, and the apparatus was decompressed until the residual pressure reached 0.1 MPaG. The process was repeated five times in total.

Subsequently, the high-pressure gas container was subjected to the cleaning step. More specifically, the container valve of the high-pressure gas container was opened. The high-pressure gas container was filled with 500 kg of hydrogen chloride having a moisture concentration of 0.2 ppm by volume or less (hydrogen halide supply stage), and then was allowed to stand for 24 hours while the temperature was maintained within a range of 15° C. or more and 25° C. or less (metal oxide removal stage). Then, the container valve of the high-pressure gas container was closed, and the container was detached from the apparatus illustrated in FIG. 1. The hydrogen chloride was discharged through a liquid phase siphon tube from the high-pressure gas container until the residual pressure reached 0.11 MPa (discharge stage). The cleaning step as above was repeated three times in total.

The high-pressure gas container after the cleaning step was refilled with 500 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 0.8 ppm by volume, and the molecular hydrogen concentration of the hydrogen chloride was 0.1 ppm by volume or less. The results are shown in Table 1.

### Example 4

A high-pressure gas container was cleaned in the same manner as in Example 1 except that the hydrogen halide used in the cleaning step was changed from hydrogen chloride having a moisture concentration of 0.2 ppm by volume or less to hydrogen bromide having a moisture concentration of 0.2 ppm by volume or less, and the amount of hydrogen bromide supplied in the hydrogen halide supply stage was 20 kg.

The high-pressure gas container after the cleaning step was refilled with 20 kg of hydrogen bromide having a moisture concentration of 0.2 ppm by volume or less. Then, the moisture concentration and the molecular hydrogen concentration of the hydrogen bromide charged in the high-pressure gas container were determined in the same manner as in Example 1. As a result, the moisture concentration of the hydrogen bromide was 0.9 ppm by volume, and the molecular hydrogen concentration of the hydrogen bromide was 0.1 ppm by volume or less. The results are shown in Table 1.

### Example 5

A high-pressure gas container was cleaned in the same manner as in Example 1 except that the cleaning step was performed once, and the temperature in the metal oxide removal stage was changed to 35° C. or more and 40° C. or less.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 0.3 ppm by volume, and the molecular hydrogen concentration of the hydrogen chloride was 12 ppm by volume. The results are shown in Table 1.

### Example 6

A high-pressure gas container was cleaned in the same manner as in Example 1 except that the inner face of the body of the high-pressure gas container had a maximum height roughness Rz of 5 μm.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 0.7 ppm by volume, and the molecular hydrogen concentration of the hydrogen chloride was 0.1 ppm by volume or less. The results are shown in Table 1.

### Example 7

A high-pressure gas container was cleaned in the same manner as in Example 1 except that the temperature in the depressurization stage was changed to 45° C. or more and 50° C. or less.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 0.3 ppm by volume, and the molecular hydrogen concentration of the hydrogen chloride was 0.1 ppm by volume or less. The results are shown in Table 1.

### Example 8

A high-pressure gas container was cleaned in the same manner as in Example 1 except that the depressurization stage was performed to reduce the pressure until the internal pressure of the high-pressure gas container reached 5 Pa.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 0.8 ppm by volume, and the molecular hydrogen concentration of the hydrogen chloride was 0.1 ppm by volume or less. The results are shown in Table 1.

### Example 9

A high-pressure gas container was cleaned in the same manner as in Example 1 except that the inert gas supply stage was performed to fill the high-pressure gas container with nitrogen gas until the internal pressure of the high-pressure gas container reached 0.1 MPa.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 0.9 ppm by volume, and the molecular hydrogen concentration of the hydrogen chloride was 0.1 ppm by volume or less. The results are shown in Table 1.

### Example 10

A high-pressure gas container was cleaned in the same manner as in Example 1 except that the inner face of the body of the high-pressure gas container had a maximum height roughness Rz of 20 μm, and the cleaning step was performed five times.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 1.2 ppm by volume, and the molecular hydrogen concentration of the hydrogen chloride was 0.1 ppm by volume or less. The results are shown in Table 1.

### Example 11

A high-pressure gas container was cleaned in the same manner as in Example 1 except that the depressurization stage was performed to reduce the pressure until the internal pressure of the high-pressure gas container reached 10 Pa.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 1.5 ppm by volume, and the molecular hydrogen concentration of the hydrogen chloride was 0.1 ppm by volume or less. The results are shown in Table 1.

### Example 12

A high-pressure gas container was cleaned in the same manner as in Example 1 except that the inert gas supply stage was performed to fill the high-pressure gas container with nitrogen gas until the internal pressure of the high-pressure gas container reached 0.05 MPa.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 1.1 ppm by volume, and the molecular hydrogen concentration of the hydrogen chloride was 0.1 ppm by volume or less. The results are shown in Table 1.

### Example 13

A high-pressure gas container was cleaned in the same manner as in Example 1 except that the vacuum accumulation purging step was performed once.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 1.3 ppm by volume, and the molecular hydrogen concentration of the hydrogen chloride was 0.1 ppm by volume or less. The results are shown in Table 1.

### Example 14

A high-pressure gas container was cleaned in the same manner as in Example 1 except that the amount of hydrogen chloride supplied in the hydrogen halide supply stage was 2 kg, and the cleaning step was performed 20 times.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 1.5 ppm by volume, and the molecular hydrogen concentration of the hydrogen chloride was 0.1 ppm by volume or less. The results are shown in Table 1.

### Example 15

A module body in which ten metal high-pressure gas containers each having a volume of 1, 100 L were connected in parallel through two manifolds was prepared (see FIG. 5). The inner face of each high-pressure gas container was polished. The inner face of the body had a maximum height roughness Rz of 1 μm, and the inner face of portions other than the body had a maximum height roughness Rz of 20 μm. The inner face of the high-pressure gas container was not coated with any coating material.

The module body was attached to the apparatus illustrated in FIG. 2 and was subjected to the vacuum accumulation purging step. More specifically, the depressurization stage was performed to reduce the pressure until the internal pressure of the high-pressure gas containers and the manifolds reached 3 Pa while the temperature was maintained within a range of 15° C. or more and 25° C. or less, and then the inert gas supply stage was performed to fill the high-pressure gas containers and the manifolds with nitrogen gas having a moisture concentration of less than 0.05 ppm by volume until the internal pressure reached 0.3 MPa. The depressurization stage and the inert gas supply stage were alternately repeated three times. The moisture concentration of the nitrogen gas charged in the high-pressure gas containers was determined with a cavity ring-down spectroscopy analyzer to be 0.1 ppm by volume or less.

Next, the module body after the vacuum accumulation purging step was depressurized in the same conditions as the depressurization stage in the vacuum accumulation purging step, and then the module body was detached from the apparatus illustrated in FIG. 2 and was attached to the apparatus illustrated in FIG. 1. Then, the container valves of all the ten high-pressure gas containers were closed. Hydrogen chloride was supplied into the apparatus illustrated in FIG. 1 and one manifold of the module body until the pressure reached 1.80 MPaG, and the apparatus and the manifold were decompressed until the residual pressure reached 0.1 MPaG. The process was repeated 15 times in total.

Subsequently, the module body was subjected to the cleaning step. More specifically, the container valves of the high-pressure gas containers were opened. Each high-pressure gas container was filled through the one manifold with 660 kg of hydrogen chloride having a moisture concentration of 0.2 ppm by volume or less (a total of 6, 600 kg of hydrogen chloride was charged) (hydrogen halide supply stage). Then, while hydrogen chloride was left so that the hydrogen chloride existed in both the gas phase and the liquid phase in the one manifold, hydrogen chloride was supplied from one high-pressure gas container to the other manifold until the pressure reached 3 MPaG.

Then, the module body was allowed to stand for 24 hours while the temperature was maintained within a range of 15° C. or more and 25° C. or less (metal oxide removal stage). Next, the container valves of the high-pressure gas containers were closed, and the module body was detached from the apparatus illustrated in FIG. 1. Hydrogen chloride was discharged from each high-pressure gas container through a liquid phase siphon tube until the residual pressure reached 0.11 MPa (discharge stage). The cleaning step as above was repeated twice in total.

Each of the high-pressure gas containers after the cleaning step was refilled with 660 kg of hydrogen chloride having a moisture concentration of 0.2 ppm by volume or less (a total of 6,600 kg of hydrogen chloride was charged). Then, the moisture concentration of the hydrogen chloride charged in the high-pressure gas containers was determined with a cavity ring-down spectroscopy analyzer, and the molecular hydrogen concentration was determined by gas chromatography. As the detector for the gas chromatography, a pulsed discharge photo-ionization detector was used. As a result, the moisture concentration of the hydrogen chloride was 0.3 ppm by volume, and the molecular hydrogen concentration of the hydrogen chloride was 0.1 ppm by volume or less. The results are shown in Table 1.

### Example 16

A module body was cleaned in the same manner as in Example 15 except that two manifolds were vacant, only ten high-pressure gas containers in the module body were each filled with 660 kg of hydrogen chloride, and the cleaning step was repeated three times in total.

Each of the high-pressure gas containers after the cleaning step was refilled with 660 kg of hydrogen chloride having a moisture concentration of 0.2 ppm by volume or less (a total of 6,600 kg of hydrogen chloride was charged). Then, the moisture concentration of the hydrogen chloride charged in the high-pressure gas containers was determined with a cavity ring-down spectroscopy analyzer, and the molecular hydrogen concentration was determined by gas chromatography. As the detector for the gas chromatography, a pulsed discharge photo-ionization detector was used. As a result, the moisture concentration of the hydrogen chloride was 0.6 ppm by volume, and the molecular hydrogen concentration of the hydrogen chloride was 0.1 ppm by volume or less. The results are shown in Table 1.

### Comparative Example 1

A high-pressure gas container was cleaned in the same manner as in Example 1 except that no vacuum accumulation purging step was performed.

The high-pressure gas container after the cleaning step was refilled with 25 kg of hydrogen chloride having a moisture concentration of 0.2 ppm by volume or less. Then, the moisture concentration and the molecular hydrogen concentration of the hydrogen chloride charged in the high-pressure gas container were determined in the same manner as in Example 1. As a result, the moisture concentration of the hydrogen chloride was 2.0 ppm by volume, and the molecular hydrogen concentration of the hydrogen chloride was 0.1 ppm by volume or less. The results are shown in Table 1.

TABLE 1

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| High- | Volume (L) | 47 | 440 | 900 | 47 | 47 | 47 | 47 | 47 |
| pressure | Maximum | 1 | 1 | 1 | 1 | 1 | 5 | 1 | 1 |
| gas | height | | | | | | | | |
| container | roughness | | | | | | | | |
| | Rz of inner | | | | | | | | |
| | face of | | | | | | | | |
| | body (μm) | | | | | | | | |
| Vacuum | Temperature in | 15-25 | 15-25 | 15-25 | 15-25 | 15-25 | 15-25 | 45-50 | 15-25 |
| accumulation | depressurization | | | | | | | | |
| purging | stage (° C.) | | | | | | | | |
| step | Pressure in | 3 | 3 | 3 | 3 | 3 | 3 | 3 | 5 |
| | depressurization | | | | | | | | |
| | stage (Pa) | | | | | | | | |
| | Pressure in | 0.3 | 0.3 | 0.3 | 0.3 | 0.3 | 0.3 | 0.3 | 0.3 |
| | inert gas | | | | | | | | |
| | supply stage | | | | | | | | |
| | (MPa) | | | | | | | | |
| | Number of | 5 | 2 | 3 | 5 | 5 | 5 | 5 | 5 |
| | times of | | | | | | | | |
| | vacuum | | | | | | | | |
| | accumulation | | | | | | | | |
| | purging | | | | | | | | |
| | step (times) | | | | | | | | |
| Cleaning | Type of HX | Hydrogen | Hydrogen | Hydrogen | Hydrogen | Hydrogen | Hydrogen | Hydrogen | Hydrogen |
| step | | chloride | chloride | chloride | chloride | chloride | chloride | chloride | chloride |
| | Filling | 25 | 250 | 500 | 20 | 25 | 25 | 25 | 25 |
| | amount of | | | | | | | | |
| | HX (kg) | | | | | | | | |
| | Reaction | 15-25 | 15-25 | 15-25 | 15-25 | 35-40 | 15-25 | 15-25 | 15-25 |
| | temperature | | | | | | | | |
| | (° C.) | | | | | | | | |
| | Reaction | 24 | 24 | 24 | 24 | 24 | 24 | 24 | 24 |
| | time (hours) | | | | | | | | |
| | Number of | 4 | 1 | 3 | 4 | 1 | 4 | 4 | 4 |
| | times of | | | | | | | | |
| | cleaning | | | | | | | | |
| | step (times) | | | | | | | | |
| HX | Type of HX | Hydrogen | Hydrogen | Hydrogen | Hydrogen | Hydrogen | Hydrogen | Hydrogen | Hydrogen |
| refilling | | chloride | chloride | chloride | chloride | chloride | chloride | chloride | chloride |
| | Filling | 25 | 250 | 500 | 20 | 25 | 25 | 25 | 25 |
| | amount | | | | | | | | |
| | of HX (kg) | | | | | | | | |
| Analysis | Moisture | 0.6 | 0.5 | 0.8 | 0.9 | 0.3 | 0.7 | 0.3 | 0.8 |
| result | concentration | | | | | | | | |
| | (ppm by volume) | | | | | | | | |
| | Molecular | 0.1 or less | 0.1 or less | 0.1 or less | 0.1 or less | 12 | 0.1 or less | 0.1 or less | 0.1 or less |
| | hydrogen | | | | | | | | |
| | concentration | | | | | | | | |
| | (ppm by | | | | | | | | |
| | volume) | | | | | | | | |

| | | Ex. 9 | Ex. 10 | Ex. 11 | Ex. 12 | Ex. 13 | Ex. 14 | Ex. 15 | Ex. 16 | Comp. Ex. 1 |
|---|---|---|---|---|---|---|---|---|---|---|
| High- | Volume (L) | 47 | 47 | 47 | 47 | 47 | 47 | 1100 | 1100 | 47 |
| pressure | Maximum | 1 | 20 | 1 | 1 | 1 | 1 | 1 | 1 | 1 |
| gas | height | | | | | | | | | |
| container | roughness | | | | | | | | | |
| | Rz of inner | | | | | | | | | |
| | face of | | | | | | | | | |
| | body (μm) | | | | | | | | | |
| Vacuum | Temperature in | 15-25 | 15-25 | 15-25 | 15-25 | 15-25 | 15-25 | 15-25 | 15-25 | — |
| accumulation | depressurization | | | | | | | | | |
| purging | stage (° C.) | | | | | | | | | |
| step | Pressure in | 3 | 3 | 10 | 3 | 3 | 3 | 3 | 3 | — |
| | depressurization | | | | | | | | | |
| | stage (Pa) | | | | | | | | | |
| | Pressure in | 0.1 | 0.3 | 0.3 | 0.05 | 0.3 | 0.3 | 0.3 | 0.3 | — |
| | inert gas | | | | | | | | | |
| | supply stage | | | | | | | | | |
| | (MPa) | | | | | | | | | |
| | Number of | 5 | 5 | 5 | 5 | 1 | 5 | 3 | 3 | 0 |
| | times of | | | | | | | | | |
| | vacuum | | | | | | | | | |
| | accumulation | | | | | | | | | |
| | purging | | | | | | | | | |
| | step (times) | | | | | | | | | |
| Cleaning | Type of HX | Hydrogen | Hydrogen | Hydrogen | Hydrogen | Hydrogen | Hydrogen | Hydrogen | Hydrogen | Hydrogen |
| step | | chloride | chloride | chloride | chloride | chloride | chloride | chloride | chloride | chloride |
| | Filling | 25 | 25 | 25 | 25 | 25 | 2 | 660 | 660 | 25 |
| | amount of | | | | | | | | | |
| | HX (kg) | | | | | | | | | |
| | Reaction | 15-25 | 15-25 | 15-25 | 15-25 | 15-25 | 15-25 | 15-25 | 15-25 | 15-25 |
| | temperature | | | | | | | | | |
| | (° C.) | | | | | | | | | |
| | Reaction | 24 | 24 | 24 | 24 | 24 | 24 | 24 | 24 | 24 |
| | time (hours) | | | | | | | | | |
| | Number of | 4 | 5 | 4 | 4 | 4 | 20 | 2 | 3 | 4 |
| | times of | | | | | | | | | |
| | cleaning | | | | | | | | | |
| | step (times) | | | | | | | | | |
| HX | Type of HX | Hydrogen | Hydrogen | Hydrogen | Hydrogen | Hydrogen | Hydrogen | Hydrogen | Hydrogen | Hydrogen |
| refilling | | chloride | chloride | chloride | chloride | chloride | chloride | chloride | chloride | chloride |
| | Filling | 25 | 25 | 25 | 25 | 25 | 25 | 660 | 660 | 25 |
| | amount | | | | | | | | | |
| | of HX (kg) | | | | | | | | | |
| Analysis | Moisture | 0.9 | 1.2 | 1.5 | 1.1 | 1.3 | 1.5 | 0.3 | 0.6 | 2.0 |
| result | concentration | | | | | | | | | |
| | (ppm by volume) | | | | | | | | | |
| | Molecular | 0.1 or less | 0.1 or less | 0.1 or less | 0.1 or less | 0.1 or less | 0.1 or less | 0.1 or less | 0.1 or less | 0.1 or less |
| | hydrogen | | | | | | | | | |
| | concentration | | | | | | | | | |
| | (ppm by | | | | | | | | | |
| | volume) | | | | | | | | | |

### REFERENCE SIGNS LIST

1: helium cylinder for purging
2: pressure reducing valve
3, 4, 6, 8, 11: valve
5: hydrogen halide supply source
7: 47-L high-pressure gas container
9: pressure gauge
10: check valve
12: discharge means
13: nitrogen gas supply source
14, 15, 16: valve
17: vacuum pump
18: vacuum gauge
19: 47-L high-pressure gas container
20: gas phase container valve
21: gas phase siphon tube
22: liquid phase siphon tube
23: liquid phase container valve
24: 440-L high-pressure gas container
25: gas phase container valve
26: liquid phase container valve
27, 30: safety valve
28: gas phase siphon tube
29: liquid phase siphon tube
31, 33: skirt
32: 900-L high-pressure gas container
34: 1100-L high-pressure gas container
35: container valve
36: module body frame
37: manifold piping
38: pressure gauge
39: manifold end valve

1. A method for cleaning a high-pressure gas container comprising:
a vacuum accumulation purging step of purging an inside of a high-pressure gas container; and
a cleaning step of cleaning the inside of the high-pressure gas container after the vacuum accumulation purging step, wherein
the vacuum accumulation purging step includes
a depressurization stage of reducing a pressure in the high-pressure gas container, and
an inert gas supply stage of supplying an inert gas to the high-pressure gas container, and
the cleaning step includes
a hydrogen halide supply stage of supplying a hydrogen halide to the high-pressure gas container after the vacuum accumulation purging step,
a metal oxide removal stage of reacting, in the high-pressure gas container after the hydrogen halide supply stage, a metal oxide on an inner face of the high-pressure gas container with the hydrogen halide supplied in the hydrogen halide supply stage to form water, and
a discharge stage of discharging the water formed in the metal oxide removal stage and the hydrogen halide supplied in the hydrogen halide supply stage from the high-pressure gas container.

2. The method for cleaning a high-pressure gas container according to claim 1, wherein the inner face of the high-pressure gas container is not coated with any coating material, and the inner face of a body of the high-pressure gas container has a maximum height roughness Rz of 5 μm or less.

3. The method for cleaning a high-pressure gas container according to claim 1, wherein the depressurization stage in the vacuum accumulation purging step is a step of discharging gas until an internal pressure of the high-pressure gas container reaches 5 Pa or less while the high-pressure gas container is maintained at a temperature of 50° C. or less, and the inert gas supply stage in the vacuum accumulation purging step is a step of supplying an inert gas having a moisture concentration of 0.1 ppm by volume or less to the high-pressure gas container until the internal pressure of the high-pressure gas container reaches 0.1 MPa or more.

4. The method for cleaning a high-pressure gas container according to claim 1, wherein the vacuum accumulation purging step is repeated twice or more.

5. The method for cleaning a high-pressure gas container according to claim 1, wherein the hydrogen halide is at least one of hydrogen fluoride, hydrogen chloride, hydrogen bromide, and hydrogen iodide.

6. The method for cleaning a high-pressure gas container according to claim 1, wherein the hydrogen halide supply stage is a step of supplying a hydrogen halide to the high-pressure gas container until the hydrogen halide is liquefied in the high-pressure gas container.

7. The method for cleaning a high-pressure gas container according to claim 1, wherein the metal oxide removal stage is a step of allowing the high-pressure gas container to which the hydrogen halide has been supplied in the hydrogen halide supply stage, to stand at a temperature of less than 30° C. for one day or more.

8. The method for cleaning a high-pressure gas container according to claim 1, wherein when the high-pressure gas container has a volume of 10 L or more and 50 L or less, the discharge stage is a step of turning the high-pressure gas container upside down to discharge the water and the hydrogen halide from the high-pressure gas container.

9. The method for cleaning a high-pressure gas container according to claim 1, wherein when the high-pressure gas container has a volume of more than 50 L and 1000 L or less, the discharge stage is a step of inserting an insertion tube into the high-pressure gas container and using the insertion tube to discharge the water and the hydrogen halide in a liquid phase from the high-pressure gas container.

10. The method for cleaning a high-pressure gas container according to claim 1, wherein when the high-pressure gas container has a volume of more than 1000 L and 1500 L or less, and two or more of the high-pressure gas containers are connected in parallel through a manifold to form a module body, the discharge stage is a step of inserting insertion tubes into the respective two or more high-pressure gas containers and using the insertion tubes to discharge the water and the hydrogen halide in a liquid phase through the manifold from the respective two or more high-pressure gas containers.

11. The method for cleaning a high-pressure gas container according to claim 10, wherein the manifold is connected to one end of each of the two or more high-pressure gas containers, or the manifolds are connected to the respective ends of each of the two or more high-pressure gas containers.

12. The method for cleaning a high-pressure gas container according to claim 1, wherein after the vacuum accumulation purging step, the cleaning step is repeated twice or more.

13. The method for cleaning a high-pressure gas container according to claim 1, wherein the metal oxide is at least one of iron oxide, chromium oxide, molybdenum oxide, and manganese oxide.

14. The method for cleaning a high-pressure gas container according to claim 2, wherein the depressurization stage in the vacuum accumulation purging step is a step of discharging gas until an internal pressure of the high-pressure gas container reaches 5 Pa or less while the high-pressure gas container is maintained at a temperature of 50° C. or less, and the inert gas supply stage in the vacuum accumulation purging step is a step of supplying an inert gas having a moisture concentration of 0.1 ppm by volume or less to the high-pressure gas container until the internal pressure of the high-pressure gas container reaches 0.1 MPa or more.

15. The method for cleaning a high-pressure gas container according to claim 2, wherein the vacuum accumulation purging step is repeated twice or more.

16. The method for cleaning a high-pressure gas container according to claim 2, wherein the hydrogen halide is at least one of hydrogen fluoride, hydrogen chloride, hydrogen bromide, and hydrogen iodide.

17. The method for cleaning a high-pressure gas container according to claim 2, wherein the hydrogen halide supply stage is a step of supplying a hydrogen halide to the high-pressure gas container until the hydrogen halide is liquefied in the high-pressure gas container.

18. The method for cleaning a high-pressure gas container according to claim 2, wherein the metal oxide removal stage is a step of allowing the high-pressure gas container to which the hydrogen halide has been supplied in the hydrogen halide supply stage, to stand at a temperature of less than 30° C. for one day or more.

19. The method for cleaning a high-pressure gas container according to claim 2, wherein when the high-pressure gas container has a volume of 10 L or more and 50 L or less, the discharge stage is a step of turning the high-pressure gas container upside down to discharge the water and the hydrogen halide from the high-pressure gas container.

20. The method for cleaning a high-pressure gas container according to claim 2, wherein when the high-pressure gas container has a volume of more than 50 L and 1000 L or less, the discharge stage is a step of inserting an insertion tube into the high-pressure gas container and using the insertion tube to discharge the water and the hydrogen halide in a liquid phase from the high-pressure gas container.
